(19) United States
(12) Patent Application Publication
(10) Pub. No.: US 2015/0261961 A1
(43) Pub. Date: Sep. 17, 2015

(54) SCENARIO-BASED SECURITY METHOD AND SYSTEM

(71) Applicants: I-Hsien CHEN, Taipei City (TW); Siang-Ci LIU, Taipei City (TW)

(72) Inventors: Wei-Cheng CHEN, Taipei City (TW); Siang-Ci LIU, Taipei City (TW); I-Hsien CHEN, Taipei City (TW)

(73) Assignees: I-Hsien CHEN, Taipei City (TW); Siang-Ci LIU, Taipei City (TW)

(21) Appl. No.: 14/215,254

(22) Filed: Mar. 17, 2014

(51) Int. Cl. G06F 21/60; G06Q 20/40; G06F 1/28; G06F 21/31

(52) U.S. Cl. CPC G06F 21/60; G06F 21/31; G06Q 20/4012; G06F 1/28

(57) ABSTRACT

A scenario-based security method and system are provided. The scenario-based security method includes a) establishing a correspondence table, the correspondence table records an account related to a first feature code and a second feature code; b) programming a standard process and a scenario-based process, the first feature code is assigned to the standard process, and the second feature code is assigned to the scenario-based process; c) a security processing module connected to the correspondence table; and d) the standard process is performed after the security processing module receiving the first feature code, or the scenario-based process is performed after the security processing module receiving the second feature code. The present invention is to provide at least one of two scenario-based feature codes related with a single account to perform a part of normal process, thereby preventing a person held the account is maliciously attacked by a ruffian.

### FIELD OF THE INVENTION

The present invention relates to code security techniques, and more particularly to provide a scenario-based security method and system to perform a security process between a purity of scenario-based security under a single account.

### BACKGROUND OF THE INVENTION

Typically, a security protection is achieved using a single password or a PIN number to access to a bank account by which an ATM card owner can use a PIN number as a security code to perform a process at an ATM terminal or make a point-of-sale transaction. An example of such method is that a bank ATM card owner must enter correct the single password to withdraw, transfer, deposit, or make other transactions from an ATM machine. Conversely, the password is incorrect, the ATM card owner cannot finish above-mentioned works.

However, the main drawback is that an illegitimate owner such as armed robber can threaten a legitimate owner to reveal a password for cash withdrawals from the ATM machines and caused financial losses for the ATM card owners. Under this scenario, the lives of ATM card owners are at stake if the robbery victim refuses to cooperate with the armed criminals.

In view of the aforesaid drawbacks of the prior art, the present invention provides scenario-based security method and system. In other word, the method and system to protect such as an ATM card owner from major financial losses in a violent and life-threatening situation.

### SUMMARY OF THE INVENTION

A first aspect of the present invention provides a scenario-based security method, an account of the method related with a first feature code and a second feature code. The first feature code call a standard process, and the second feature code call a scenario-based process, the scenario-based process includes a part of the standard process. When the scenario-based process is executed, an illegitimate owner (e.g. a thief, a robber) is not easy to be conscious. In addition, a security process (or a security mechanism) is also starting up after executing the scenario-based process.

A second aspect of the present invention provides above scenario-based security method, corresponded process is executed according to a user select one of the first feature code or the second feature code.

A third aspect of the present invention provides a scenario-based security system, the system is embedded to a financial computing and transactions systems, an electronic apparatus enabling a password security management or vehicle anti-theft system to protect an legitimate owner from major financial losses in a violent and life-threatening situation.

A fourth aspect of the present invention provides above scenario-based security system, the legitimate owner utilizes a plurality of feature codes (e.g. (a) password: a number type, a graph type, a symbol type, and combination therefor; (b) biological characteristic: a finger print, an iris, a vein, etc.) to set a correspond process. Correspond process includes a standard process and a scenario-based process.

of wherein a password owner can adopt a plurality of preset processes corresponding to different sets of feature codes consisting of numbers, letters, and symbols, or combination, or/and different sets of feature codes based on bio features or biometrics identifications such as fingerprint and Iris recognitions. The processes include a standard process and a scenario-based process. A further object of the invention is to provide the scenario-based security and protection method and system providing false information to an illegitimate password request and lengthening the process of a malicious attack on transactions and malicious manipulations of an electronic apparatus and a vehicle.

In order to achieve the above and other objectives, the present invention provides a scenario-based security method. The method includes a) establishing a correspondence table, the correspondence table records an account related to a first feature code and a second feature code; b) programming a standard process and a scenario-based process, the first feature code is assigned to the standard process, and the second feature code is assigned to the scenario-based process; c) a security processing module connected to the correspondence table; and d) the standard process is performed after the security processing module receiving the first feature code, or the scenario-based process is performed after the security processing module receiving the second feature code.

In order to achieve the above and other objectives, the present invention provides a scenario-based security system comprising a database and a security processing module. The database is consisted of a reference table recording an account, a first feature code, a second feature code, a standard process, and a scenario-based process, wherein the account corresponding to the first feature code and the second feature code, the first feature code is assigned to the standard process, and the second feature code is assigned to the scenario-based process. The security processing module connecting to the database, the security processing module performs the standard process after the security processing module receiving the first feature code, or the security processing module performs the scenario-based process after the security processing module receiving the second feature code.

Comparing with the prior art, the present invention provides a scenario-based security method and system to enable a legitimate password access to determine the execution of a standard process or/and a scenario-based process according to different scenarios. Under the standard process, a legitimate owner can perform a standard process completely. Under the scenario-based process, an illegitimate owner just allows to perform a part of the standard process. In addition, it also performs a security process as inconspicuous as possible, such as track, identify, and locate the user. Since the security process is similar to the standard process, the illegitimate owner is not easy to be conscious.

### BRIEF DESCRIPTION OF THE DRAWINGS

Objectives, features, and advantages of the present invention are hereunder illustrated with specific embodiments in conjunction with the accompanying drawings, in which:

FIG. 1 is a flowchart of scenario-based security method according to an embodiment of the present invention;

FIG. 2 is a block diagram of scenario-based security system according to an embodiment of the present invention;

FIG. 3 is a schematic view of scenario-based security method is applied to a physical or a virtual financial transaction according to an embodiment of the present invention;

FIG. 4 is a schematic view of scenario-based security method is applied to a portable electronic equipment according to an embodiment of the present invention; and

FIG. 5 is a schematic view of scenario-based security method is applied to a vehicle according to an embodiment of the present invention.

### DETAILED DESCRIPTION OF THE PREFERRED EMBODIMENTS

As indicated above, the invention provides a scenario-based security method and system. The following comprises preferred embodiments of the invention, which describe different aspects of the present invention.

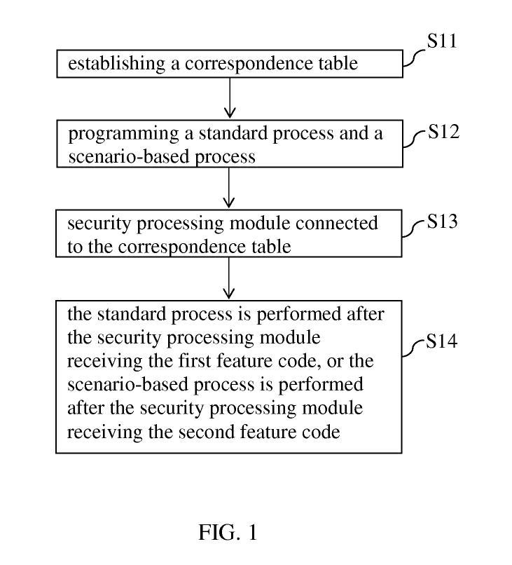

Referring to FIG. 1, there is shown a flowchart of scenario-based security method according to an embodiment of the present invention. As shown in FIG. 1, the method is starting at step S11, establishing a correspondence table, the correspondence table records an account related to a first feature code and a second feature code. In the embodiment of the present invention, the correspondence table establishes the association between the feature codes and the account. More particularly, the account is belong an owner (hereinafter referred to as a legitimate owner). The owner predetermine to arrange the first feature code and the second feature code corresponding to the account. For example, the first feature code and the second feature code include a number type, a letter type, a symbols, or combination therefor.

The legitimate owner or an illegitimate owner (e.g. a thief, a robber, etc.) utilizes a keyboard to enter the number type, the letter type, the symbols, or combination therefor to create/generate the first feature code and the second feature code corresponding to the account. In other embodiment, the legitimate owner or an illegitimate owner may use an image recognition apparatus retrieval a biological characteristic or a biometrics to create/generate the first feature code and the second feature code corresponding to the account, for example the biological characteristic includes a lineaments, a finger print, a voice point, an iris, signature, and posture, etc.

Step S12 is programming a standard process and a scenario-based process, the first feature code is assigned to the standard process, and the second feature code is assigned to the scenario-based process. In another embodiment, the scenario-based process may be same the standard process. In the embodiment of the present invention, the scenario-based process comprises a part of the standard process, which refers to a complete process. The scenario-based process relates to a restrictive process designed for protecting the legitimate owners' lives and financial safety. The standard process and scenario-based process can be used as an embedded solution for a financial computing and transaction system, an electronic device applications, a vehicle anti-theft applications, a warehousing and logistics management and security systems, and a human resource management systems detailed in the following paragraphs.

Step S13 is a security processing module connected to the correspondence table. In this Step, the security processing module is a programming code type or/and physical apparatus type. The security processing module analyzes the first feature code or the second feature code generated from the legitimate owner or an illegitimate owner.

Step S14 is the standard process is performed after the security processing module receiving the first feature code, or the scenario-based process is performed after the security processing module receiving the second feature code. In other words, the security processing module executes the standard process on receipt of the first feature code in accordance with the correspondence table or/and executes a scenario-based process on receipt of the second feature code in accordance with the correspondence table.

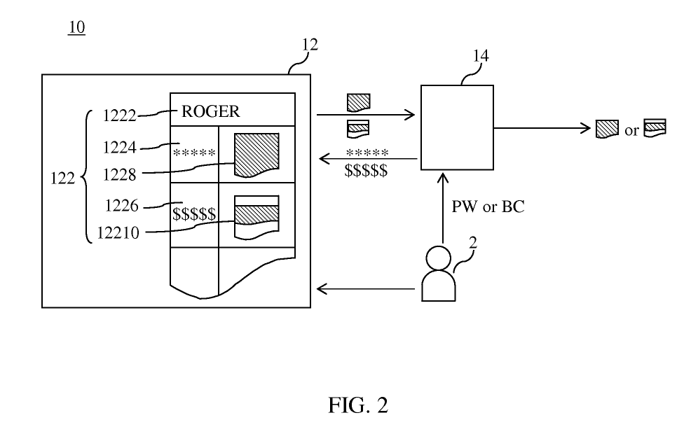

Referring to FIG. 2, there is shown a block diagram of scenario-based security system according to an embodiment of the present invention. As shown in FIG. 2, the security system 10 includes a database 12 and a security processing module 14.

The database 12 comprises a correspondence table 122 which records an account 1222. The account 1222 includes a plurality of fields which stores a first feature code 1224, a second feature code 1226, a standard process 1228, and a scenario-based process 12210. It worthy to understand that the standard process 1228 and the scenario-based process 12210 are represent as a program code, a sub program, and function.

The account 1222 is related with the first feature code 1224 and the second feature code 1226. In further embodiment of the present invention, the invention provides the legitimate owner adding more two feature codes if necessary. The first feature code 1224 is corresponded to the standard process 1228, and the second feature code 1226 corresponds to the scenario-based process 12210.

The standard process 1228 and the scenario-based process 12210 can be used as an embedded solution for a financial computing and a transaction system, an electronic device applications, a vehicle anti-theft applications, a warehousing management system, a logistics management system, and a human resource management systems, etc.

The security processing module 14 is connected to the database 12. The security processing module 14 execute the standard process 1228 or the scenario-based process 12210, according to the security processing module 14 receives the first feature code 1224 or the second feature code 1226.

For example, the security processing module 14 includes an input device and a recognition device (no shown in FIG. 2). The input device may be a keyboard, an image capturing device, a mouse, and a biometric identification system, etc.

In further embodiment of the invention, the input device is connected to the recognition device. The legitimate owner 2 (or the illegitimate owner) utilizes the input device to capture a password PW or a biological characteristic BC form the legitimate owner 2 (or the illegitimate owner). The recognition device analyzes the password PW or the biological characteristic BC and utilizes an algorithm for converting the password PW or the biological characteristic BC into the first feature code 1224, the second feature code 1226, and additional feature codes that are not shown in FIG. 2.

The scenario-based security system 10 is applied to other embodiments, they will be detailed in the following paragraphs.

### 1) A Physical or Virtual Financial Transactions Platform

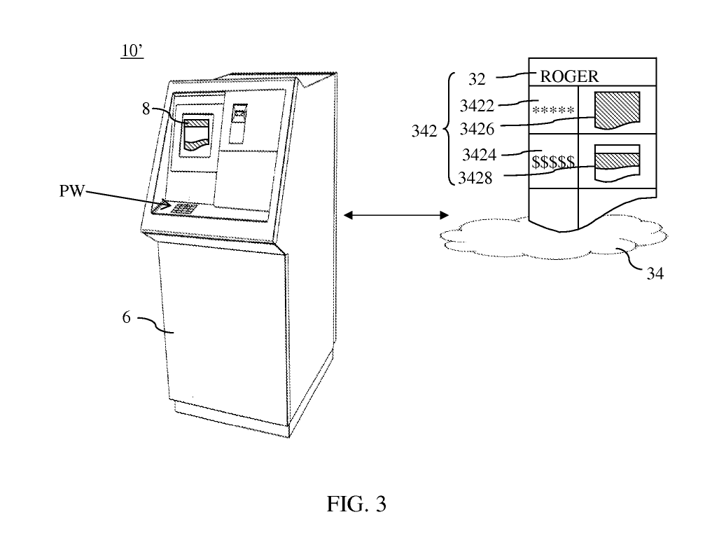

Referring to FIG. 3, is a schematic view of scenario-based security method is applied to a physical or a virtual financial transaction according to an embodiment of the present invention. The scenario-based security system 10 is used as an embedded an automatic teller machine (ATM) 6. In normal scenario, the legitimate owner inserts an ATM card into the ATM 6. The ATM executes a financial transaction 8. The financial transaction display a withdrawal function, a deposit function, a transfer function, an inquiry function on an ATM screen after receipting the password PW entry by at least a user or ATM card owner. The ATM 6 performs a financial transaction selected by at least a user or ATM card owner.

The legitimate owner 2 applied a checking or savings account at a bank. The bank established a bank account database 34 including a correspondence table 342. The legitimate owner 2 presets a first feature code 3422 and a second feature code 3424 in the correspondence table 342. The first feature code 3422 corresponds to a standard process 3426 and the second feature code 3424 corresponds to a scenario-based process 3428 in the correspondence table 342.

The standard process 3426 is initiated on receipt of the first feature code 3422 input by at least a user or ATM card owner on the ATM 6, enabling a user or ATM card owner to perform the individual types of transaction including a withdrawal, a deposit, a transfer, and an inquiry. In other words, the standard process 3426 refers to execution of a transaction on the ATM 6.

The scenario-based process 3428 is initiated on receipt of the second feature code 3424 input by at least a user or ATM card owner on the ATM 6, enabling at least a user or ATM card owner to perform the individual types of transaction. 1) In first type, the withdrawal, the deposit, the transfer, and the inquiry are preformed normally, but a financial security process is also performed. 2) In second type, the process allows at least a user or ATM card owner to perform the requested transaction partially or to withdraw limited amount of money, thereby enabling the ATM 6 to perform the financial security process. 3) In third type, the ATM 6 displays a false information about the requested withdrawal goes beyond the remaining available balance, or/and screen of out of services due to a planned maintenance or system upgrade, enabling The ATM 6 to perform a financial security process.

More particularly, the scenario-based process 3428 is directed to a method managing a scenario wherein the a user is an armed robber threatening the ATM card owner to provide the second feature code following acquisition of the first feature code 3424. The owner involuntarily provides the second feature code 3424 to the robber and thus the robber can input the second feature code 3424 to initiate the scenario-based process 3428, enabling the ATM owner to send message to notify a police, a security guard company, and a bank staffs to rescue the ATM owner of robbery and arrest the robber.

The financial security process comprises: a1) ATM 6 activates an alarm signal to notify the policy, the security guard company, and the bank staffs; b1) the ATM 6 installing a protection equipment including remote power door lock system or remote control roll-up doors trapping an escaping robber; c1) the ATM 6 discontinuing requested transition partially to restrict robbers' access to the ATM 6; d1) the ATM 6 activating an image capture system for video-recording of the ATM robbery; e1) inserting/installing a tracking device like GPS transmitter hidden in the withdrawn money to trace the money.

In other embodiment of the present invention, the scenario-based security is used in financial security comprises provides a method of protection against cyber ATM robbery using a PC. The process enables the tracking of the Internet protocol (IP) for the police and the Internet service providers from an ATM to reverse trace an IP address and locate robbers anywhere.

As indicated in the preceding paragraphs, the present invention provides a scenario-based security and protection method and system, which can be used in a physical or a virtual financial transactions platform.

### 2) Portable Electronic Equipment

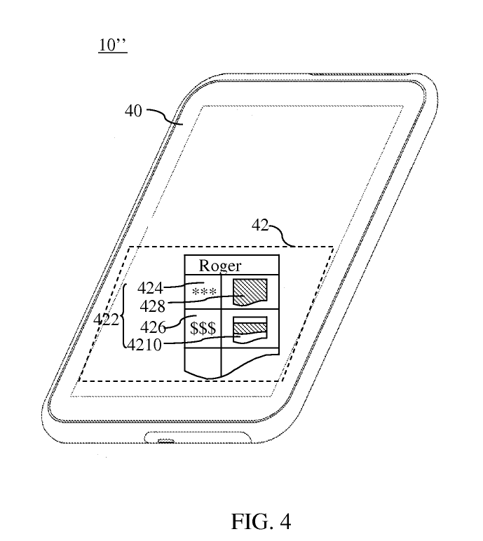

Referring to FIG. 4, is a schematic view of scenario-based security method is applied to a portable electronic equipment according to an embodiment of the present invention. A person owns a mobile device 40. In this case, a smartphone is the mobile device, which features the identification authentication for operating the smartphone. The scenario-based security system 10″ is used as an embedded OS solution or APP in the smartphone, enabling the smartphone to execute the scenario-based process, thereby discouraging a robber to operate the smartphone or/and prolong the ATM Wireless connectivity process.

The smartphone connected to a database 42 including a correspondence table 422. The smartphone owner preset a first feature code 424 and a second feature code 426 in the correspondence table 422. A first feature code 424 corresponds to a standard process 428 and a second feature code 426 corresponds to a scenario-based process 4210 in the correspondence table 422.

The standard process 428 allows the smartphone owner to operate all function including making phone calls, checking contacts or address book and texted messages, downloading apps. In other words, the standard process 428 refers to execution of a transaction on the smartphone.

The scenario-based security process 4210 comprises at least of a part of functions and an electrical apparatus security process comprises: a2) initiating a security process by displaying false information of an insufficient available power when the thief gains access to the smartphone, thereby discouraging the thief's smartphone use; in one embodiment of the invention, the scenario-based process include a display of charging process on the smartphone, system restart, smartphone owner's cover page, etc.; b2) sending a warming message form the smartphone to a smartphone owner, a policy, a security guard company, a telecommunications company, and a related web sites when the theft uses the smartphone without arousing the thief's suspicions; c2) activating a tracking device such as the global positioning system (GPS) to send the location of thief using the smartphone to the smartphone owner, the policy security guard company, the telecommunications company, and related web sites when the theft uses the smartphone; d2) activating a mobile connectivity device featuring Wi-Fi connections, long term evolution (LTE), 3G or 4G, and WiMAX technologies to send a message of illegitimate smartphone use to the smartphone owner, the policy security guard company, the telecommunications company, and related web sites when the theft uses the smartphone; e2) suspending call-out service but allowing restricted call-in services on the smartphone; f2) identifying the IP address of the smartphone to trace and locate the smartphone, and then sending the related messages to the smartphone owner, the policy security guard company, the telecommunications company, and the related web sites; g2) activating an image capture device for video-recording the thief use of the smartphone and then sending the related footage to the smartphone owner, the policy security guard company, the telecommunications company, and the related web sites.

In further embodiment of the invention, the scenario-based security and protection method and system used in a mobile device switches the display from a screen of insufficient available power to a screen of power charging, and then execute the processes indicated in b2˜g2 if the thief uses an external charger.

### 3) Vehicle

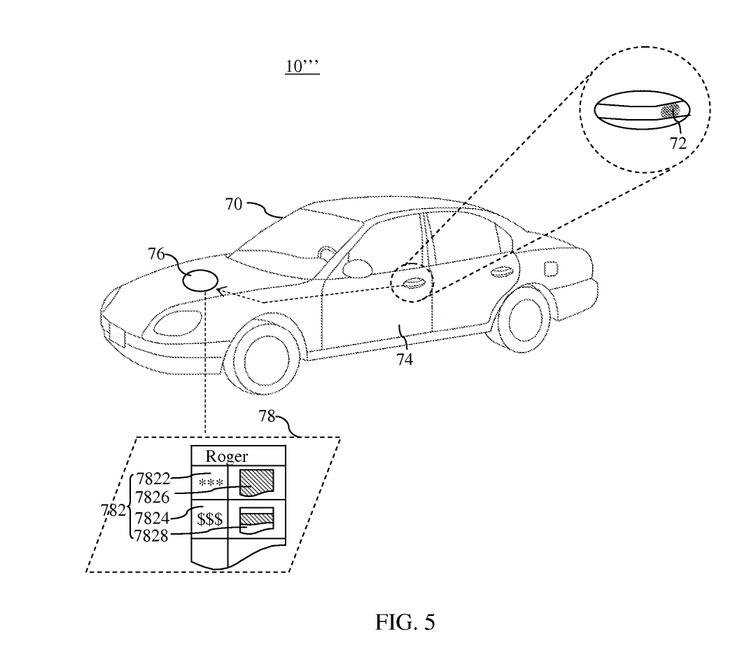

Referring to FIG. 5, is a schematic view of scenario-based security system is applied to a vehicle according to an embodiment of the present invention. In this case, an owner of the car 70 can use his or her fingerprint 72 to open a door 74 and drive the car 70. In one embodiment of the invention, the scenario-based security system 10′″ is used as an embedded in a vehicle computer 76 to prevent against motor vehicle theft and improve a vehicle positioning process.

The vehicle computer 76 in the car 70 is connected to a database 78 consisting of a correspondence table 782. The owner of the car 70 preset a first feature code 7822 and a second feature code 7824 in the correspondence table 782. The first feature code 7822 corresponds to a standard process 7826 and a second feature code 7824 corresponds to a scenario-based process 7828 in the correspondence table 422.

The standard process 7826 allows the owner of the car 70 to use all functions of the car 70 and to initiate a car engine, turn on instrument panel and a vehicle computer, etc.

The scenario-based security process 7828 comprises at least of a part of functions and a vehicle security process, which provides a plurality of security processes. In one embodiment of the invention, the security process comprises: a3) displaying a security protection signal on the instrument panel of the car 70 to arouse thief's suspicions about navigation safety. Such as the instrument panel displays at least one of low fuel indicator and a Breakdown indicator; b3) sending/outputting an alarm signal to emit high-volume sound when the thief starts the engine to attract others' attention; c3) using the tracking and positioning device on the car 70 to trace and locate the car and then send the related messages to a car owner, a policy security a guard company, a car company, and a related web sites; d3) activating a wireless connection device to send messages including navigation routes, signals on the instrument panel and data in the event data recorder to the car owner, the policy security guard company, the car company, and the related web sites; e3) suspending other user's operations partially like engine staring and implementing restrictions on driving distance, driving speed, gear shifting, and wheel shifting in further embodiment of the invention, f3) activating the image capture device in an event data record of the car 70 to send the driving records to a car owner, a policy security guard company, a car company, and related web sites; g3) activating auto lock system to trap the thief in the car prior to the arrivals of the car owner, policy security guard company and car company staffs.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A scenario-based security method comprising:
establishing a correspondence table, the correspondence table records an account related to a first feature code and a second feature code;
programming a standard process and a scenario-based process, the first feature code is assigned to the standard process, and the second feature code is assigned to the scenario-based process;
a security processing module connected to the correspondence table; and
the standard process is performed after the security processing module receiving the first feature code, or the scenario-based process is performed after the security processing module receiving the second feature code.

2. A scenario-based security system comprising:
a database, consisting of a reference table recording an account, a first feature code, a second feature code, a standard process, and a scenario-based process, wherein the account corresponding to the first feature code and the second feature code, the first feature code is assigned to the standard process, and the second feature code is assigned to the scenario-based process; and
a security processing module connecting to the database, the security processing module performs the standard process after the security processing module receiving the first feature code, or the security processing module performs the scenario-based process after the security processing module receiving the second feature code.

3. A scenario-based security system of claim 2, wherein the security processing module is applied to a financial transaction process, wherein the standard process is a financial transaction process, a scenario-based process related with at least a part of the financial transaction process or a financial security process.

4. A scenario-based security system of claim 3, wherein the financial security process consists of at least one of outputting an alarm signal, starting up a protection system, suspending transaction process partially, tracing an IP address, activating an image capture device, and inserting a trace device into the system.

5. A scenario-based security system of claim 3, wherein the financial transaction process is performed in a physical or a virtual financial transactions platform.

6. A scenario-based security system of claim 2, wherein the security processing module is embedded in a mobile device, wherein the standard process is a first operation authorization, the scenario-based process related with at least a part of the first operation authorization and an electrical apparatus security process.

7. A scenario-based security system of claim 6, wherein the electronic apparatus security process consists of at least one of displaying a security screen, outputting an alarm signal, starting up a position tracking device, starting up an internet module, suspending the first operation authorization, tracing an IP address, and activating an image capture devices.

8. A scenario-based security system of claim 7, wherein the security screen displays a screen of insufficient available power, a screen of power charging, a screen of system restarting, and a screen of holder information.

9. A scenario-based security system of claim 8, wherein the electrical apparatus security process further comprising at least one of changing the screen of insufficient power available to a screen of power charging after detecting a power generated from an external power.

10. A scenario-based security system of claim 2, wherein the security processing module is applied to a vehicle, wherein the standard process is a second operation authorization, and the scenario-based process related with at least of a part of the second operation authorization and a vehicle security process.

11. A scenario-based security system of claim 10, wherein the vehicle security process consists of at least one of displaying a security protection signal on an instrument panel, outputting an alarming signal, starting up a position tracking device, tracing an IP address, suspending the second operation authorization, activating an image capture devices, and locking a door and window.

12. A scenario-based security system of claim 11, wherein the instrument panel displays at least one of low fuel indicator and a Breakdown indicator.

13. A scenario-based security system of claim 11, wherein suspended the second operation authorization includes at least one of engine restart limitation, driving distance limitation, driving speed limitation, gearshift limitation, and steering wheel limitation.

14. A scenario-based security system of claim 2, wherein the first feature code and the second feature codes are converted from a biological characteristic.
